(19) United States
(12) Patent Application Publication
(10) Pub. No.: US 2015/0319009 A1
(43) Pub. Date: Nov. 5, 2015

(54) Method and Device for VLAN Interface Routing

(71) Applicant: TELEFONAKTIEBOLAGET L M ERICSSON (PUBL), Stockholm (SE)

(72) Inventor: Zhengfu Zhao, Beijing (CN)

(73) Assignee: Telefonaktiebolaget L M Ericsson (publ), Stockholm (SE)

(21) Appl. No.: 14/651,013

(22) PCT Filed: Dec. 12, 2012
(86) PCT No.: PCT/CN2012/086423

§ 371 Date: Jun. 10, 2015

(51) Int. Cl. H04L 12/46; H04L 29/06; H04L 12/741

(52) U.S. Cl. CPC H04L 12/4675; H04L 12/4645; H04L 45/74; H04L 69/22

(57) ABSTRACT

One of the embodiments of the present invention relates to a method for routing frames via a node with at least one VLAN—“Virtual Local Area Network” interface which is configured to process frames associated with at least one VLAN. The method comprises: receiving an ingress frame at a source physical port of said node, wherein said ingress frame carries one or more VLAN tags and each of said VLAN tags is arranged to identify one VLAN ID; determining a forwarding destination for said frame within or among at least one service domain; and transmitting a corresponding egress frame at a destination physical port of said node, wherein said egress frame carries one or more VLAN tags and each of said VLAN tags is arranged to identify one VLAN ID. The embodiments of the present invention further provide corresponding network node device and computer program product.

### TECHNICAL FIELD

The embodiments of the present invention generally relate to network communication, particularly to a method and device for Virtual Local Area Network (VLAN) interface routing.

### DESCRIPTION OF THE RELATED ART

VLAN is widely used in network to isolate different customer traffic. Like in case of a usual physical separated network subsystem, each VLAN builds its own broadcast domain created by switches and is connected with other VLANs via intermediate nodes with destination forwarding functionality, such as routers and/or switchers. In the VLAN the data frames are switched according to the control information in the frame header included tags identifying the assignment of the frames to a particular VLAN. After the data frames are transmitted on their respective VLANs through the corporate network, the VLAN tag may be stripped before the data frame is sent.

Mechanism for sharing of a physical Ethernet network link by multiple independent logical networks by using the tags is standardized in IEEE 802.1Q, or VLAN Tagging. In IEEE 802.1Q, each Ethernet frame is tagged with a VLAN tag in the 802.1Q header of data frame to identify uniquely a VLAN for purpose of bridging. The 802.1Q header reserves 12 bits for a VLAN tag allowing an allocation of 4094 different VLANs (some values are reserved). There are standards like e.g., from IEEE that allow double (or so called “stacked”) VLAN tags, e.g., IEEE 802.ad Provider Bridge. This standard adds another VLAN tag into the IEEE 802.1Q frame. This results in 4094*4094 available VLANs. The double VLAN tags are inner VLAN Identification (VLAN_ID) tag and outer VLAN_ID tag to identify so-called the inner VLAN and outer VLAN, respectively.

In the industrial, routers may adopt two kinds of VLAN routing interfaces on the basis of VLAN_ID to route the data frames within or among VLANs, i.e., VLAN Interface (VLAN_IF) and Virtual Port Interface (VP_IF) (also referred as to Subport Interface).

The VP_IF is generated from port and VLAN_ID. The limitation is that one VP_IF should always consist of one port, and different VP_IFs on the same node shall with the different IP subnets. When the port is down, the IP interface of that VP_IF is broken down.

The VLAN_IF is generated from only one VLAN_ID and provides the Layer 3 processing for frames from one or more the Layer 3 processing for frames from one or more ports associated with the one VLAN. The main characteristics of the VLAN_IF are that all the IP interfaces from different nodes, which are connected together by the same VLAN_ID shall have the same IP subnet. The source MAC address for that VLAN_IF can be the network element scope significant L3 Media Access Control (MAC) address. Since the VLAN_IF is mapped to only one VLAN, it neither supports the routing of frames carrying double tags identifying both inner and outer VLANs nor provides advanced VLAN interface routing with more flexible VLAN operations.

Therefore, there is need to provide a solution of VLAN interface routing so as to provide advanced VLAN interface routing.

### SUMMARY OF THE INVENTION

One or more method and apparatus embodiments according to the present invention aim to provide a solution for VLAN interface routing via a node building at least one VLAN interface.

According to an aspect of the present invention, an embodiment of the present invention provides a method for routing frames via a node with at least one VLAN interface which is configured to process frames associated with at least one VLAN. The method comprises receiving an ingress frame at a source physical port of the node. The ingress frame carries one or more VLAN tags and each of the VLAN tags is arranged to identify one VLAN ID. The method further comprises determining a forwarding destination for the frame within or among at least one service domain. Each of the at least one service domain is specified by one service ID and at least one service interface ID associated with the service ID. The service ID is one-to-one mapped with one VLAN interface, and each of the at least one service interface ID is mapped to a combination of at least one VLAN_ID and a physical port ID. The method further comprises transmitting a corresponding egress frame at a destination physical port of the node. The egress frame carries one or more VLAN tags and each of the VLAN tags is arranged to identify one VLAN ID.

According to an aspect of the present invention, an embodiment of the present invention provides a network node device for routing frames via at least one VLAN interface, which is configured to process frames associated with at least one VLAN. The network node comprises a receiving unit configured to receive an ingress frame at a source physical port of the network node. The ingress frame carries one or more VLAN tags and each of the VLAN tags is arranged to identify one VLAN ID. The network node further comprises a determining unit configured to determine a forwarding destination for the frame within or among at least one service domain. Each of the at least one service domain is specified by one service ID and at least one service interface ID associated with the service ID. The service ID is one-to-one mapped with one VLAN interface, and each of the at least one service interface ID is mapped to a combination of at least one VLAN_ID and a physical port ID. The network node further comprises a transmitting unit configured to transmit a corresponding egress frame at a destination physical port of the network node. The egress frame carries one or more VLAN tags and each of the VLAN tags is arranged to identify one VLAN ID.

According to one or more embodiments of the present invention, various practical VLAN routing scenarios can be easily implemented with more flexible VLAN routing operations.

### BRIEF DESCRIPTION OF THE DRAWINGS

Inventive features regarded as the characteristics of the present invention are set forth in the appended claims. However, the present invention, its implementation mode, other objectives, features and advantages will be better understood through reading the following detailed description on the exemplary embodiments with reference to the accompanying drawings, where in the drawings:

FIG. 1A is a block diagram schematically illustrating an exemplary routing scenario, which may be supported by a network node 100 building at least one conventional VLAN interface;

FIG. 1B schematically illustrates VLAN interface configuration of the network node 100 in the routing scenario as shown in FIG. 1A;

FIG. 2A is a block diagram schematically illustrating an exemplary routing scenario, which may be supported by a network node 200 building at least one VLAN interface according to an embodiment of the present invention;

FIG. 2B schematically illustrates VLAN interface configuration of the network node 200 in the routing scenario as shown in FIG. 2A;

FIG. 3 schematically illustrates an exemplary flow chart of a method for routing frames via a node building at least one VLAN interface according to an embodiment of the present invention;

FIG. 4 schematically illustrates an exemplary flow chart of a process of determining forwarding destination within or among at least service domain according to an embodiment of the present invention; and

FIG. 5 is a block diagram schematically illustrating a network node device for routing frames via at least one VLAN interface according to an embodiment of the present invention.

### DETAILED DESCRIPTION OF THE PREFERRED EMBODIMENT

Hereinafter, embodiments of the present invention will be described with reference to the accompanying drawings. In the following description, many specific details are illustrated so as to understand the present invention more comprehensively. However, it is apparent to the skilled in the art that implementation of the present invention may not have these details. Additionally, it should be understood that the present invention is not limited to the particular embodiments as introduced here. On the contrary, any arbitrary combination of the following features and elements may be considered to implement and practice the present invention, regardless of whether they involve different embodiments. Thus, the following aspects, features, embodiments and advantages are only for illustrative purposes, and should not be understood as elements or limitations of the appended claims, unless otherwise explicitly specified in the claims.

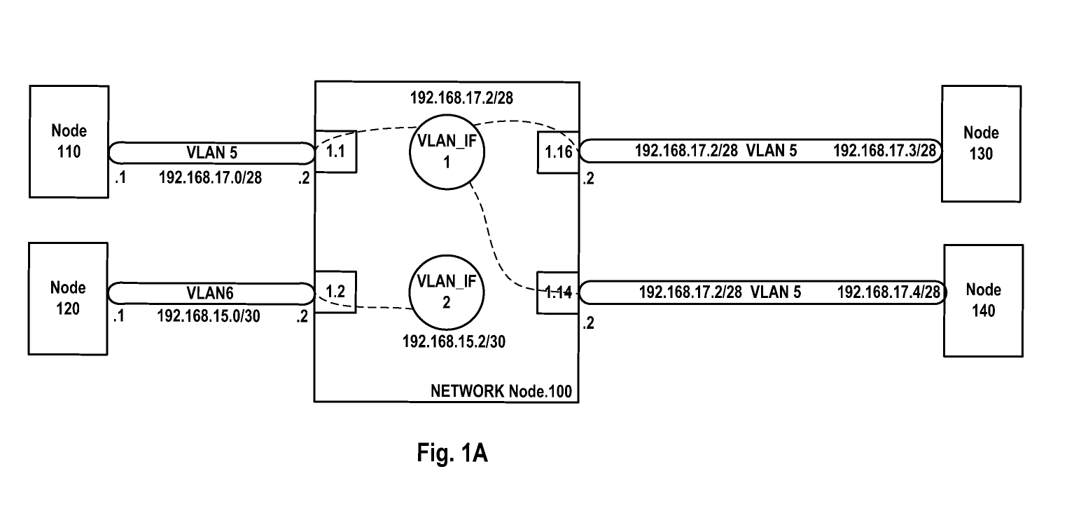

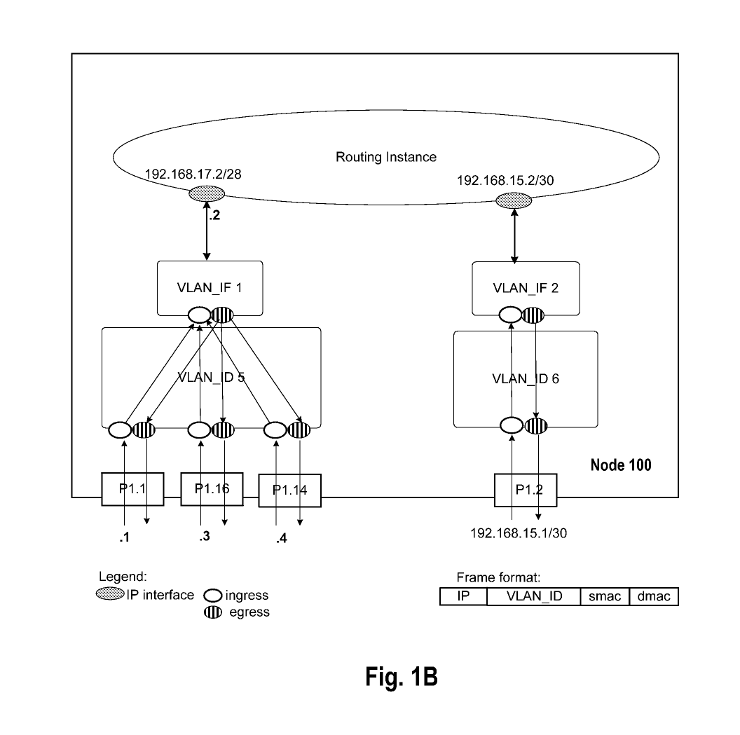

FIG. 1A is a block diagram schematically illustrating an exemplary routing scenario, which can be implemented with a network node 100 building at least one conventional VLAN interface.

In the routing scenario as shown in FIG. 1, the network node 100 provides nodes 110, 120, 130 and 140 with connectivity to each other. The network node 100 may be a router in a network system to perform destination forwarding for Ethernet frames received from the nodes 110, 120, 130 and 140 over VLANs. Each of the nodes 110, 120, 130 and 140 can be either a subscriber node or another network node to provide network connectivity.

The network node 100 builds VLAN interfaces such as the VLAN_IF 1 and VLAN_IF 2, each of which is configured to process frames associated with one VLAN. In general, the term “interface” is used herein to refer to a software interface that is created or otherwise instantiated within a network node device to support network communication. Therefore, those skilled in the art can distinguish the term “interface” from “physical port” or “port” in technical aspect.

The VLAN_IF 1 is built for a VLAN 5, to which the nodes 110, 130 and 140 are connected through the ports 1.1, 1.16 and 1.14, respectively. All the IP interfaces from different nodes 110, 130 and 140 connected together by the same VLAN via the VLAN_IF 1 shall have the same IP subnet, as shown in FIG. 1, 192.168.17.0/28 subnet for the VLAN_ID 5.

The VLAN_IF 2 is built for a VLAN 6, to which the node 120 is connected through the port 1.2. The IP interface from the node 120 connected via the VLAN_IF 2 has 192.168.15.2/30 subnet for the VLAN_ID 6.

FIG. 1B schematically illustrates VLAN interface configuration of the network node 100 in the routing scenario as shown in FIG. 1A.

As shown in FIG. 1B, the VLAN_IF 1 is one-to-one mapped to the VLAN_ID 5 and is assigned to an IP address 192.168.17.2/28. Since the ports 1.1, 1.16, 1.14 are all associated with VLAN_IF 1, all ingress frames and egress frames at those ports 1.1, 1.16, 1.14 have to carry VLAN tags identifying the same VLAN ID, i.e., VLAN_ID 5. For any single port, for example, the port 1.16, two different ingress frames or two different egress frames must have the same VLAN ID. i.e., VLAN_ID 5.

Similarly, the VLAN_IF 2 is one-to-one mapped to the VLAN_ID 6 and is assigned to an IP address 192.168.15.2/30. The port 1.2 is connected to the VLAN 6 and therefore is associated with VLAN_IF 2. For the port 1.2, two different ingress frames or two different egress frames must have the same VLAN ID. i.e., VLAN_ID 6.

It can be seen that the node 100 building conventional VLAN interfaces cannot support double tagged frames for routing. Nor can it support other more complicated routing scenarios, for example, double tagged frames with different inner VLAN_ID (Custom-VLAN) and the same outer VLAN_ID (Service-VLAN) for different ports inside the same VLAN_ID for routing, etc., which may be used in service provider networks.

One or more embodiments of the present invention provide a network node building at least one VLAN interface enhanced by service-domain destination forwarding, by which ingress frames, which may carry one or more VLAN tags are received at a source physical port of the network node and can be switched or routed within or among one or more service domains; and thus a corresponding egress frame that may carry one or more the same or different VLAN tags are transmitted at a destination physical port of the network node. According to one or more embodiment of the present invention, each of at least one service domain is specified by one service ID and at least one service interface ID associated with service ID, wherein the service ID is one-to-one mapped with one VLAN interface, and each of the at least one service interface ID is mapped to a combination of at least one VLAN_ID and a physical port ID.

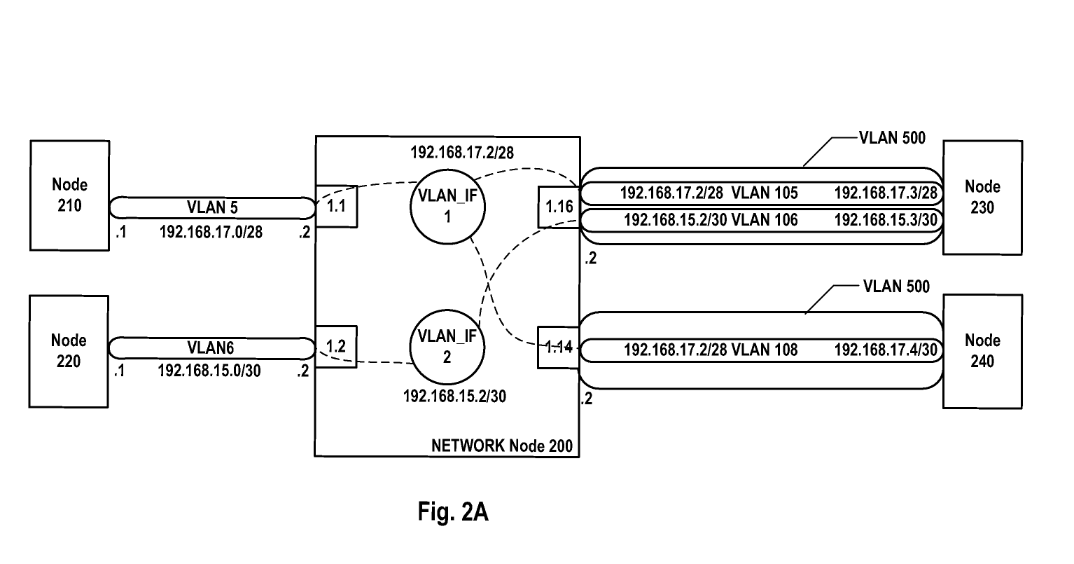

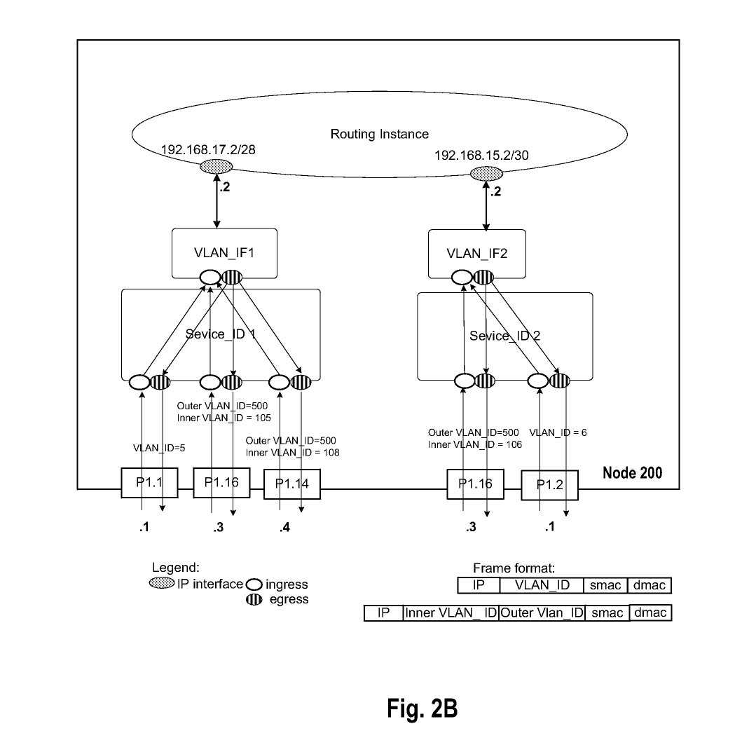

FIG. 2A is a block diagram schematically illustrating an exemplary routing scenario, which may be implemented with a network node 200 building at least one VLAN interface according to an embodiment of the present invention.

In the routing scenario as shown in FIG. 2A, the network node 200 provides nodes 210, 220, 230 and 240 with connectivity to each other. The network node 200 may be a router in a network system to perform destination forwarding for Ethernet frames received from the nodes 210, 220, 230 and 240 over VLANs, as described above for the network node 100. Each of the nodes 210, 220, 230 and 240 can be either a subscriber node or another network node to provide network connectivity.

The network node 200 builds VLAN interfaces VLAN_IF 1 and VLAN_IF 2, which are enhanced by novel service-domain destination forwarding so as to support more flexible VLAN routing operations than the conventional VLAN interface.

As shown in FIG. 2A, although the nodes 210, 230, 240 are coupled to the VLAN_IF 1 and share the same IP subnet of 192.168.17.0/28, the VLANs to which they are connected are different one from another. For instance, in a first direction of the VLAN_IF 1, the node 210 is connected to the VLAN 5 through the port 1.1; in a second direction of the VLAN_IF 1, the node 230 is connected to double VLANs through the port 1.16, i.e., a custom VLAN 105 and a service VLAN 500; and in a third direction of the VLAN_IF 1, the node 240 is connected to double VLANs through the port 1.14, i.e., a custom VLAN 108 and the service VLAN 500.

Similarly, the nodes 220 and 230 are coupled to the VLAN_IF 2 and share the same IP subnet of 192.168.15.0/30. However, the VLANs to which the nodes 220 and 230 are connected are different from each other. For instance, in a first direction of the VLAN_IF 2, the node 220 is connected to the VLAN 6 through the port 1.2; and in a second direction of the VLAN_IF 2, the node 230 is connected to double VLANs through the port 1.16, i.e., a custom VLAN 106 and the service VLAN 500.

In the scenario of FIG. 2A, the port 1.16 is associated with both the VLAN_IF 1 and VLAN_IF 2 so as to enable to route or switch double tagged frames with different inner VLAN_ID (e.g., the custom VLAN 105 and the custom VLAN 106) and the same outer VLAN_ID (the service VLAN 500).

FIG. 2B schematically illustrates VLAN interface configuration of the network node 200 in the routing scenario as shown in FIG. 2A.

As shown in FIG. 2B, the VLAN_IF 1 is configured to be one-to-one mapped to a service domain, which in this example is identified by a service_ID 1 and is assigned to an IP address 192.168.17.2/28. The service domain is specified by one service ID, such as the service_ID 1, and one or more interface IDs, such as service interface_IDs 1, 2 and 3 (not shown) associated with the service_ID 1. Each of the service interface IDs, such as the service interface_IDs 1, 2 and 3, is configured to be mapped to a combination of at least one VLAN_ID and a physical port ID. In the exemplary scenario of FIG. 2B, for the service domain 1, the service interface_ID 1 may be configured to be mapped to a combination of the VLAN_ID 5 and the port_ID 1.1; the service interface_ID 2 may be configured to be mapped to a combination of the outer VLAN_ID 500, inner VLAN_ID 105 and the port_ID 1.16; and the service interface_ID 3 may be configured to be mapped to a combination of the outer VLAN_ID 500, inner VLAN_ID 108 and the port_ID 1.14.

Similarly, the VLAN_IF 2 is configured to be one-to-one mapped to a service domain, which in this example is identified by a service_ID 2 and is assigned to an IP address 192.168.15.2/30. The service domain is specified by the service_ID 2 and service interface_IDs 1 and 2 (not shown) associated with the service_ID 2. Each of the service interface_IDs 1, 2 is configured to be mapped to a combination of at least one VLAN_ID and a physical port ID. In the exemplary scenario of FIG. 2B, for the service domain 2, the service interface_ID 1 may be configured to be mapped to the outer VLAN_ID 500, inner VLAN_ID 106 and the port ID 1.16; and the service interface_ID 2 may be configured to be mapped with a combination of the VLAN_ID 6 and the port ID 1.2.

It can be appreciated that the above described mapping relationship used for configuring each of the service domains is predetermined based on any desired VLAN routing scenario, such as the scenario as shown in FIG. 2A. Advantageously, the service ID may be node scope significant and the service interface ID may be service domain scope significant. Alternatively, the service interface ID may also be node scope significant. Traffic inside the network node 200 can be routed and/or switched on the basis of the service domains.

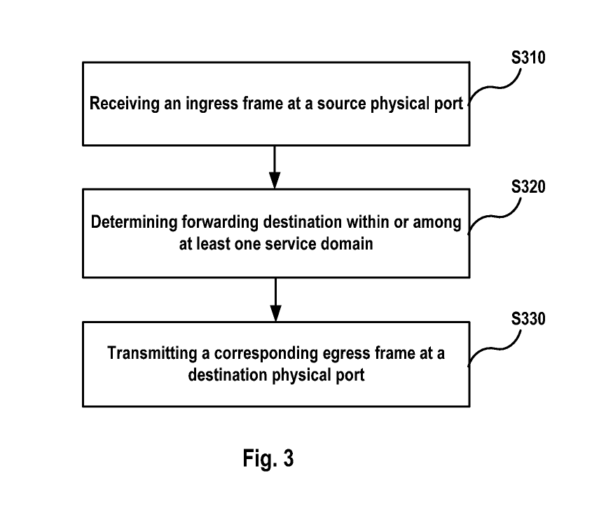

FIG. 3 schematically illustrates an exemplary flow chart of a method for routing frames via a node building at least one VLAN interface according to an embodiment of the present invention.

In step S310, an ingress frame is received at a source physical port of a network node such as for example the network node 200.

The ingress frame may be a single-tagged frame carrying only one VLAN tag or a double-tagged frame carrying both inner VLAN tag and outer VLAN tag. Each of the VLAN tags is arranged to identify one VLAN ID.

In step S320, a forwarding destination is determined for the frame within or among at least one service domain so as to determine to which physical port of the network node the frame is going to be forwarded, i.e., a destination physical port and to determine one or more VLAN IDs which should be identified respectively by one or more VLAN tags carried in a corresponding egress frame.

According to one or more embodiments of the present invention, each of the at least one service domain is specified by one service ID and at least one service interface ID associated with the service ID, wherein the service ID is one-to-one mapped with one VLAN interface, and each of the at least one service interface ID is mapped to a combination of at least one VLAN_ID and a physical port ID.

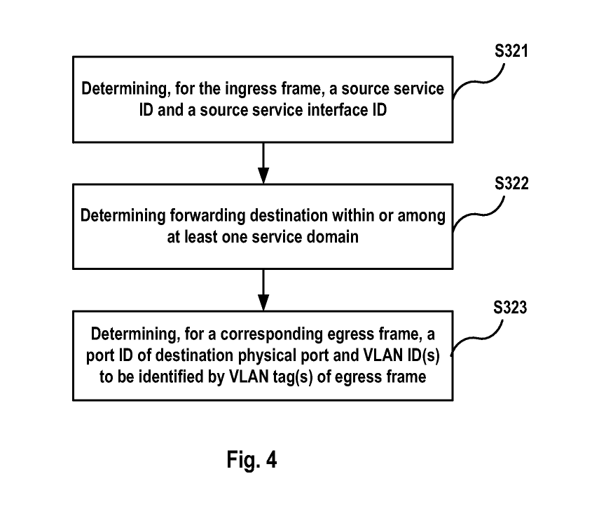

The process of destination forwarding within or among at least service domain is similar to that well known in the prior art except that the VLAN_ID is replaced by the service ID and the port ID is replaced by the service interface ID. An exemplary process of destination forwarding within or among at least one service domain will be discussed in detail below with reference to FIG. 4.

In step S330, the corresponding egress frame is transmitted at the destination physical port of the network node.

The egress frame may be a single-tagged frame carrying only one VLAN tag or a double-tagged frame carrying both inner VLAN tag and outer VLAN tag, which can be determined in step 320. Each of the VLAN tags is arranged to identify one VLAN ID.

FIG. 4 schematically illustrates an exemplary flow chart of a process of determining forwarding destination within or among at least service domain according to an embodiment of the present invention.

As shown in FIG. 4, in step S321, based on a pre-configured ingress direction mapping relationship, a source service ID and a source service interface ID for the ingress frame may be determined dependent upon a port ID of the source physical port of the ingress frame and at least one VLAN ID identified by the one or more VLAN tags carried in the ingress frame.

Considering the routing scenario shown in FIG. 2A and FIG. 2B as an example, the traffic frames incoming to a port such as any port of P 1.1, P1.2, P1.16, P 1.14 are classified by the source port_ID, VLAN_ID(s) including a single tagged VLAN ID or outer VLAN ID and inner VLAN ID of the frame so as to be mapped into a corresponding service domain based on the predetermined ingress direction mapping relationship. In an implementation, the ingress direction mapping relationship may be represented by an ingress mapping table, for example as shown in Tab. 1. To simply the description, in Tab. 1, the inner VLAN_ID is shown as an optional key value and can be maskable for a single tagged frame, untagged frame or priority tagged frame. In case of an untagged or priority tagged frame, it may be predefined to use its port-based VLAN ID as the key value of Outer VLAN_ID for looking up the ingress mapping table Tab. 1.

TABLE 1
Ingress Mapping Table

| | Key | Key (optional) | | Result |
|---|---|---|---|---|
| Key | VID or | Inner VID | Result | Service |
| Port_ID | Outer VID | (maskable) | Service_ID | Interface_ID |
| P1.1 | 5 | N/A | 1 | 1 |
| P1.2 | 6 | N/A | 2 | 2 |
| P1.16 | 500 | 105 | 1 | 2 |
| P1.16 | 500 | 106 | 2 | 1 |
| P1.14 | 500 | 108 | 1 | 3 |

In the illustrated embodiment, ingress frames, which are received at the port 1.1 over the VLAN 5 are mapped into a service domain identified by the service_ID 1 and are assigned with the service interface_ID 1; ingress frames which are received at the port 1.16 over the outer VLAN 500 and inner VLAN 105 and ingress frames which are received at the port P1.14 over the outer VLAN 500 and inner VLAN 108 are mapped into the same service domain with the service_ID 1 and are assigned with the service interface_IDs 2 and 3, respectively. Ingress frames which are received at the port 1.16 over the outer VLAN 500 and inner VLAN 106 are mapped into a service domain identified by the service_ID 2 and are assigned with the service interface_ID 1; and ingress frames which are received at the port 1.2 over the VLAN 6 are mapped into the same service domain identified by the service_ID 2 and are assigned with the service interface ID 2. As such, a source service ID and a source service interface ID for any ingress frame can be determined by for example looking up the ingress mapping table by using the ingress frame's port_ID and VLAN_ID(s) as key values.

In step S322, a destination service ID and a destination service interface ID for the frame is determined at least partially dependent upon the determined source service ID and source service interface ID.

In an embodiment of the present invention, Layer-2 switching of the frame can be performed within one service domain in the case that the source service ID of the ingress frame is identical to the destination service ID of the corresponding egress frame.

In an implementation, the determined source service ID and the destination MAC carried in the ingress frame is looked up in the local node MAC address lookup table. If the destination MAC address matches any forwarding MAC address (the MAC address is not one of local node MAC addresses) in the MAC address look up table, the frame will get the destination service interface ID from the present local node MAC address lookup table; otherwise, if no matches, the ingress frame is multicast in that service ID domain except for the ingress service interface ID. In this situation, the destination service ID is identical to the source service ID of the ingress frame. Consequently, Layer-2 switching of the frame can be performed within the service domain to get the destination service ID and destination service interface ID.

In an embodiment of the present invention, Layer-3 routing of the frame can be performed among service domains in the case that the source service ID of the ingress frame is different from the destination service ID of the corresponding egress frame.

In an implementation, the determined source service ID and the destination MAC carried in the ingress frame is looked up in the local node MAC address lookup table. If the destination MAC address of the ingress frame matches one of the local node MAC addresses, the frame will be sent to routing logic. In this situation, the destination service ID of the egress frame is different from the source service ID of the ingress frame. Consequently, the Layer-3 routing logic will determine the next hop and the destination service ID and service interface ID of the corresponding egress frame.

Those skilled in the art should appreciate that in an implementation, all processes that may be involved in the Layer-2 switching and/or Layer-3 routing, such as destination MAC lookup in a MAC address lookup table, source MAC address learning and unknown unicast MAC address frame handling, etc. may follow the standard IEEE 802.1D/Q behavior but the VLAN ID should be replaced by the corresponding service ID, the physical port ID should be replaced by the corresponding service interface ID. Indeed, with the introduction of the service domain destination forwarding, those skilled in the art may adopt any other suitable strategies or processes for routing or switching traffic frames on a basis of one or more VLAN interface built in a network node, as long as the VLAN_ID can be replaced by the corresponding service ID and the physical port ID can be replaced by the corresponding service interface ID. It should be understood that such replacement is obvious to those skilled in the art when taking the teaching of various embodiments of the present invention into consideration.

In step S323, based on a pre-configured egress direction mapping relationship, a port ID of the destination physical port and at least one VLAN ID to be identified by the one or more VLAN tags of the egress frame are determined dependent upon the determined destination service ID and destination service interface ID.

Again, considering the example of the routing scenario shown in FIGS. 2A and 2B, the traffic frames outgoing to a port such as any port of P 1.1, P1.2, P1.16, P 1.14 are classified by the determined destination service ID and service interface ID so as to be mapped, based on the predetermined egress direction mapping relationship, into a corresponding combination of a physical port ID and at VLAN_ID(s) including a single tagged VLAN ID or outer VLAN ID and inner VLAN ID of the frame. In an implementation, the egress direction mapping relationship may be represented by an egress mapping table, for example as shown in Tab. 2. To simply the description, in Tab. 2, the inner VLAN_ID is shown as a optional result and can be maskable for a single tagged frame, untagged frame or priority tagged frame, just similar to Tab. 1. In the case of an untagged or priority tagged frame, it may be predefined that its port-based VLAN ID can be obtained as the result value of outer VLAN_ID in looking up the egress mapping table Tab. 2.

TABLE 2
Egress Mapping Table

| | Key | | Result | Result (optional) |
|---|---|---|---|---|
| Key | Service | Result | VID or | Inner VID |
| Service_ID | Interface_ID | Port_ID | Outer VID | (maskable) |
| 1 | 1 | P1.1 | 5 | N/A |
| 1 | 2 | P1.16 | 500 | 105 |
| 1 | 3 | P1.14 | 500 | 108 |
| 2 | 1 | P1.16 | 500 | 106 |
| 2 | 2 | P1.2 | 6 | N/A |

In the illustrated embodiment, for egress frames belonging to the service domain identified by the service_ID 1, frames assigned with the service interface_ID 1 are mapped to a combination of the physical port 1.1 and the VLAN_ID 5; the frames assigned with the service interface_ID 2 are mapped to a combination of at the port 1.16 and the outer VLAN 500 and inner VLAN 105; and frames assigned with service interface_ID 3 are mapped to a combination of the port P1.14 through the outer VLAN 500 and inner VLAN 108. For egress frames belonging to the service domain identified by the service_ID 2, frames assigned with the service interface_ID 1 are mapped to a combination of the physical port 1.16 and the outer VLAN_ID 500 and inner VLAN_ID 106; and frames assigned with the service interface_ID 2 are mapped to a combination of the physical port 1.2 and the VLAN_ID 6. As such, a port ID of the destination physical port and at least one VLAN ID to be identified by the one or more VLAN tags of the egress frame can be determined by for example looking up the egress mapping table by using the determined destination service_ID and destination service interface_ID.

Although the exemplary processing flows illustrated in FIGS. 3 and 4 are discussed with respect to the exemplary routing scenario as shown in FIGS. 2A and 2B, those skilled in the art may appreciate that embodiments according to the present invention will not limit to any specific routing scenario but can be used for supporting a variety of practical routing scenarios as desired.

According to an embodiment of the present invention, at least one of an ingress frame and its corresponding egress frame carries two VLAN tags which are arranged to identify an inner VLAN ID and an outer VLAN ID.

In an exemplary scenario, two different ingress frames mapped to the same service domain may have the same outer VLAN ID and different inner VLAN ID; and/or two different egress frames mapped from the same service domain may have the same outer VLAN ID and different inner VLAN ID.

In another exemplary scenario, two different single-tagged ingress frames mapped to the same service domain may have different VLAN ID; and/or two different egress frames mapped from the service domain may have the same outer VLAN ID and different inner VLAN ID.

In yet another exemplary scenario, two different double-tagged ingress frames mapped to the same service domain may have the same outer VLAN ID and different inner VLAN ID; and/or two different single-tagged egress frames mapped from the same service domain may have different VLAN ID.

The processes described herein for routing frame via a network node building at least one VLAN interface may be advantageously implemented via software, hardware, firmware or a combination of software and/or firmware and/or hardware. For example, the processes described herein, including service domain mapping, Layer-2 switching and Layer-3 routing, etc., may be advantageously implemented via ternary content addressable memory (TCAM), processor(s), Digital Signal Processing (DSP) chip, an Application Specific Integrated Circuit (ASIC), Field Programmable Gate Arrays (FPGAs), etc.

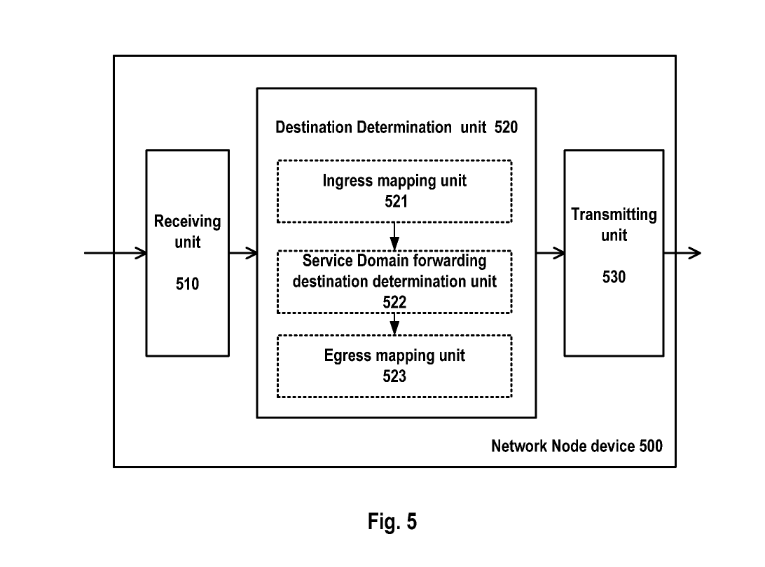

FIG. 5 is a block diagram schematically illustrating a network node device 500 for routing frames via at least one VLAN interface according to an embodiment of the present invention.

As shown in FIG. 5, a network node device 500 is used for routing frames via at least one VLAN interface built therein. The at least VLAN interface is configured to process frames associated with at least one VLAN.

The network node device 500 comprises: a receiving unit 510, a determining unit 520, a transmitting unit 530, among others.

The receiving unit 510 is configured to receive an ingress frame at a source physical port of the network node device 500, wherein the ingress frame carries one or more VLAN tags and each of the VLAN tags is arranged to identify one VLAN ID.

The determining unit 520 is configured to determine a forwarding destination for the frame within or among at least one service domain, wherein each of the at least one service domain is specified by one service ID and at least one service interface ID associated with the service ID, wherein the service ID is one-to-one mapped with one VLAN interface, and each of the at least one service interface ID is mapped to a combination of at least one VLAN_ID and a physical port ID.

The transmitting unit 530 is configured to transmit a corresponding egress frame at a destination physical port of the network node device 500, wherein the egress frame carries one or more VLAN tags and each of the VLAN tags is arranged to identify one VLAN ID.

According to an embodiment of the present invention, the determining unit 520 may comprise: a service domain ingress mapping unit 521, a service domain destination determination unit 522, and a service domain egress mapping unit 523.

In an embodiment of the present invention, the service domain ingress mapping unit 521 may be configured to determine, based on a pre-configured ingress direction mapping relationship, a source service ID and a source service interface ID for the ingress frame, dependent upon a port ID of the source physical port of the ingress frame and at least one VLAN ID identified by the one or more VLAN tags carried in the ingress frame.

In an embodiment of the present invention, the service domain destination determination unit 522 may be configured to determine a destination service ID and a destination service interface ID for the frame, at least partially dependent upon the determined source service ID and source service interface ID.

In an embodiment, the service domain destination determination unit 522 may be configured to perform Layer-2 switching of the frame within one service domain in the case that the source service ID is identical to the destination service ID and perform Layer-3 routing of the frame among different service domains in the case that the source service ID is different from the destination service ID.

In an embodiment of the present invention, the service domain egress mapping unit 523 maybe configured to determine, based on a pre-configured egress direction mapping relationship, a port ID of the destination physical port and at least one VLAN ID to be identified by the one or more VLAN tags of the egress frame, dependent upon the determined destination service ID and destination service interface ID.

Although the service domain ingress and egress mapping units 521 and 523 are shown as two separate units of the network node device 500 in FIG. 5, they can also be integrated into one single service domain mapping unit (not shown) to perform the operations relating to service domain mapping in both ingress and egress directions.

It can be seen that the network node device 500 according to an embodiment of the present invention builds at least one advanced VLAN interface enhanced by service-domain destination forwarding, by which ingress frames that may carry one or more VLAN tags are received at a source physical port of the network node 500 and can be switched or routed within or among one or more service domains; and thus a corresponding egress frame that may carry one or more the same or different VLAN tags are transmitted at a destination physical port of the network node. Consequently, the network node device 500 is able to support various practical VLAN routing scenarios and implement flexible VLAN routing operations.

In general, the various exemplary embodiments may be implemented in hardware or special purpose circuits, software, logical or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block and signaling diagrams, it is well understood that these blocks, apparatus, systems, techniques or methods described herein may be implemented in, as non-limiting examples, hardware, software, firmware, special purpose circuits or logical, general purpose hardware or controller or other computing devices, or some combination thereof.

As such, it should be appreciated that at least some aspects of the exemplary embodiments of the inventions may be practiced in various components such as integrated circuit chips and modules. As well known in the art, the design of integrated circuits is by and large a highly automated process.

The present invention may also be embodied in the computer program product which comprises all features capable of implementing the method as depicted herein and may implement the method when loaded to the computer system.

The present invention has been specifically illustrated and explained with reference to the preferred embodiments. The skilled in the art should understand various changes thereto in form and details may be made without departing from the spirit and scope of the present invention.

1-14. (canceled)

15. A method for routing frames via a node with at least one Virtual Local Area Network (VLAN) interface which is configured to process frames associated with at least one VLAN, said method comprising:
receiving an ingress frame at a source physical port of said node, wherein said ingress frame carries one or more VLAN tags and each of said VLAN tags is arranged to identify one VLAN ID;
determining a forwarding destination for said frame within or among at least one service domain, wherein each of said at least one service domain is specified by one service ID and at least one service interface ID associated with said service ID, wherein said service ID is one-to-one mapped with one VLAN interface, and each of said at least one service interface ID is mapped to a combination of at least one VLAN_ID and a physical port ID; and
transmitting a corresponding egress frame at a destination physical port of said node, wherein said egress frame carries one or more VLAN tags and each of said VLAN tags is arranged to identify one VLAN ID.

16. The method according to claim 15, wherein said step of determining a forwarding destination comprises:
based on a pre-configured ingress direction mapping relationship, determining a source service ID and a source service interface ID for said ingress frame, dependent upon a port ID of said source physical port of said ingress frame and at least one VLAN ID identified by said one or more VLAN tags carried in said ingress frame;
determining a destination service ID and a destination service interface ID for said frame at least partially dependent upon the determined source service ID and source service interface ID; and
based on a pre-configured egress direction mapping relationship, determining a port ID of said destination physical port and at least one VLAN ID to be identified by said one or more VLAN tags of said egress frame, dependent upon the determined destination service ID and destination service interface ID.

17. The method according to claim 16, wherein said step of determining a destination service ID and a destination service interface ID for said frame comprises:
performing, in the case that said source service ID is identical to said destination service ID, Layer-2 switching of said frame within one service domain; and
performing, in the case that said source service ID is different from said destination service ID, Layer-3 routing of said frame among different service domains.

18. The method according to claim 15, wherein
at least one of said egress frame and said ingress frame carries two VLAN tags which are arranged to identify an inner VLAN ID and an outer VLAN ID.

19. The method according to claim 18, wherein
two different egress frames have the same outer VLAN ID and different inner VLAN ID; and/or
two different ingress frames have the same outer VLAN ID and different inner VLAN ID.

20. The method according to claim 18, wherein
two different egress frames have the same outer VLAN ID and different inner VLAN ID; and/or
two different ingress frames have different VLAN ID.

21. The method according to claim 18, wherein
two different egress frames have different VLAN ID; and/or
two different ingress frames have the same outer VLAN ID and different inner VLAN ID.

22. A network node device for routing frames via at least one Virtual Local Area Network (VLAN) interface, which is configured to process frames associated with at least one VLAN, said network node device comprising:
a receiving unit configured to receive an ingress frame at a source physical port of said network node device, wherein said ingress frame carries one or more VLAN tags and each of said VLAN tags is arranged to identify one VLAN ID;
a determining unit configured to determine a forwarding destination for said frame within or among at least one service domain, wherein each of said at least one service domain is specified by one service ID and at least one service interface ID associated with said service ID, wherein said service ID is one-to-one mapped with one VLAN interface, and each of said at least one service interface ID is mapped to a combination of at least one VLAN_ID and a physical port ID; and
a transmitting unit configured to transmit a corresponding egress frame at a destination physical port of said network node device, wherein said egress frame carries one or more VLAN tags and each of said VLAN tags is arranged to identify one VLAN ID.

23. The network node device according to claim 22, wherein said determining unit comprises:
a service domain ingress mapping unit configured to determine, based on a pre-configured ingress direction mapping relationship, a source service ID and a source service interface ID for said ingress frame, dependent upon a port ID of said source physical port of said ingress frame and at least one VLAN ID identified by said one or more VLAN tags carried in said ingress frame;
a service domain destination determination unit configured to determine a destination service ID and a destination service interface ID for said frame, at least partially dependent upon the determined source service ID and source service interface ID; and
a service domain egress mapping unit configured to determine, based on a pre-configured egress direction mapping relationship, a port ID of said destination physical port and at least one VLAN ID to be identified by said one or more VLAN tags of said egress frame, dependent upon the determined destination service ID and destination service interface ID.

24. The network node device according to claim 23, wherein said service domain destination determination unit is configured to:
perform, in the case that said source service ID is identical to said destination service ID, Layer-2 switching of said frame within one service domain; and
perform, in the case that said source service ID is different from said destination service ID, Layer-3 routing of said frame among different service domains.

25. The network node device according to claim 22, wherein
at least one of said egress frame and said ingress frame carries two VLAN tags which are arranged to identify an inner VLAN ID and an outer VLAN ID.

26. The network node device according to claim 25, wherein
two different egress frames have the same outer VLAN ID and different inner VLAN ID; and/or
two different ingress frames have the same outer VLAN ID and different inner VLAN ID.

27. The network node device according to claim 25, wherein
two different egress frames have the same outer VLAN ID and different inner VLAN ID; and/or
two different ingress frames have different VLAN ID.

28. The network node device according to claim 25, wherein
two different egress frames have different VLAN ID; and/or
two different ingress frames have the same outer VLAN ID and different inner VLAN ID.
